(19) United States
(12) Patent Application Publication
(10) Pub. No.: US 2026/0178505 A1
(43) Pub. Date: Jun. 25, 2026

(54) PRE-EMPTIVE INVALIDATION AND DELAYED FLUSHING FOR DISTRIBUTED CACHE SYSTEMS

(71) Applicant: Mercedes-Benz Group AG, Stuttgart (DE)

(72) Inventor: Shweta Jain, Sunnyvale, CA (US)

(21) Appl. No.: 18/991,082

(22) Filed: Dec. 20, 2024

(51) Int. Cl. G06F 12/0891

(52) U.S. Cl. CPC G06F 12/0891

(57) ABSTRACT

An electronic control unit is provided to manage a distributed cache system to reduce data transfer. In examples, the ECU can include a plurality of distributed processing resources (e.g., chiplets), as well as control logic to for the distributed processing resources to perform with respect to their cached data when workloads are completed. The distributed processing system is used to control or perform functions for a vehicle, including functions to automate operation of a vehicle.

### TECHNICAL BACKGROUND

Examples relate to a distributed cache system, and more specifically, to pre-emptively invalidating and delaying flushing for distributed cache systems.

### BACKGROUND

Caches are small, fast, memory units used to store frequently accessed data by the CPU. The cache memory hides the latency of accessing the data from the slower main memory by reducing the number of accesses by the CPU to the main memory. In a distributed cache system, the cache controller maintains coherency amongst the different cache resources. When contents of a main memory are distributed to more than one cache resource, the cache controller maintains coherency of the data amongst the cache resources. Under conventional approaches, the cache controller maintains coherency using a Modified, Shared and Invalid (“MSI”) protocol, or a Modified, Exclusive, Shared and Invalid (“MESI”) protocol. These protocols typically introduce significant complexity and overhead for a cache controller.

A cache flushing operation is one of the primary operations performed to manage cache. When cache content is updated with respect to a main memory, a flush operation can be performed to write the cache content back to the main memory, thereby updating the main memory. On the other hand, an invalidation operation is typically performed when the same cache line exists in multiple caches, and then one of the caches locally modifies the cache line. By comparison, a cache invalidation operation requires far less data transfer than a cache flushing operation

### SUMMARY

An electronic control unit (ECU) is provided to manage a distributed cache system to reduce data transfer. In examples, the ECU can include a plurality of distributed processing resources (e.g., chiplets), as well as conrol logic to for the distributed processing resources to perform with respect to their cached data when workloads are completed. In examples, the distributed processing system is used to control or perform functions for a vehicle, including functions to automate operation of a vehicle.

According to examples, an ECU operates to make a determination as to whether a cache content used in execution of a first workload of the plurality of workloads by a first chiplet of the plurality of chiplets is changed as a result of the first workload being executed by the first chiplet. Based on the determination, one or more cache management operations are selected to manage the cache content.

In additional examples, an ECU is configured to make a determination as to whether a cache content used in execution of a first workload is changed. A cache management action is selected from a set of multiple cache management actions based at least in part on the determination. Performance is initiated of one or more operations for implementing the cache management action.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system in which embodiments described herein may be implemented, in accordance with examples described herein.

FIG. 2 illustrates an electronic control unit (ECU) that manages a distributed cache system, according to one or more embodiments.

FIG. 3 is a block diagram illustrating a vehicle control unit, according to one or more embodiments.

FIG. 4A and FIG. 4B illustrate example methods for managing a distributed cache system, according to one or more embodiments.

### DETAILED DESCRIPTION

Examples as described include an electronic control unit (“ECU”) having processing resources (e.g., chiplets) to control and/or perform functions in a dynamic, active and data intense computing environment. An example ECU can be implemented as a system on chip (SoC), multiple systems of chip (mSoC), or other types of distributed processing architectures for handling high volumes of data. To reduce latency, an example ECU as described leverages the use of cache memory to store frequently accessed data. As described, an example ECU includes a distributed processing system, where each distributed processing resource is associated with a corresponding cache resource. As further described with examples, the cache resources of a distributed processing system can be managed from a centralized processing resource, to implement cache management operations that maintain coherency, while also minimizing the occurrence of congestion on interconnects between a main memory and a cache resource of a distributed processing resource.

Examples include an ECU for managing a distributed cache system to reduce data transfer. Further, an example includes an ECU to pre-emptively invalidate and delay flushing for a distributed cache system.

While examples can be implemented in numerous types of computing environments, specific examples are provided in context of robotics and autonomous vehicles. Autonomous vehicles, for example, consume large amounts of data in environments that require real-time or even near instantaneous responsiveness. Examples as described enable an ECU to optimize its use of cache resources based on an objective of reducing congestion and overhead that would otherwise occur as a result of maintaining coherency and correctness amongst the cache resources being used by the distributed processing resources. By managing cache-induced congestion and avoiding instances where interconnect elements of the distributed processing system are bottlenecked as a result of caching operations, an example ECU is able to improve performance and efficiency.

An electronic control unit (ECU) is provided to manage a distributed cache system to reduce data transfer. In examples, the ECU can include a plurality of distributed processing resources (e.g., chiplets), as well as control logic to for the distributed processing resources to perform with respect to their cached data when workloads are completed. In examples, the distributed processing system is used to control or perform functions for a vehicle, including functions to automate operation of a vehicle.

According to examples, an ECU operates to make a determination as to whether a cache content used in execution of a first workload of the plurality of workloads by a first chiplet of the plurality of chiplets is changed as a result of the first workload being executed by the first chiplet. Based on the determination, one or more cache management operations are selected to manage the cache content.

In additional examples, an ECU is configured to make a determination as to whether a cache content used in execution of a first workload is changed. A cache management action is selected from a set of multiple cache management actions based at least in part on the determination. Performance is initiated of one or more operations for implementing the cache management action.

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### Example Computing System

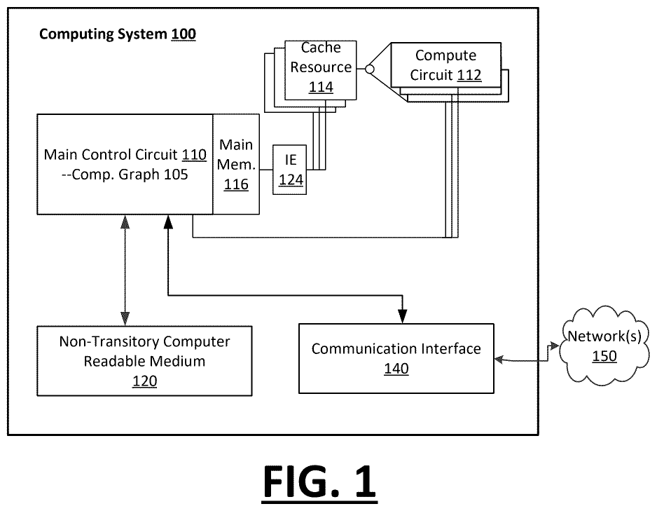

FIG. 1 is a block diagram depicting an example computing system 100 in which embodiments may be implemented, in accordance with examples described herein. In an embodiment, the computing system 100 includes a main control circuit 110, and one or more compute circuits 112 that are distributed on a backplane, board or die. Each of the main control circuit 110 and the one or more compute circuits 112 can be in the form of processor (e.g., microprocessor), a processing core, a programmable logic circuit (PLC) or a programmable logic/gate array (PLA/PGA), a field programmable gate array (FPGA), an application specific integrated circuit (ASIC), systems on chip (SoCs), multiple systems on chip (mSoC) or any other combination of control or compute circuit. In some implementations, the control circuit 110 and/or computing system 100 may be part of, or may form, an electronic control unit (“ECU”) for use in a dynamic, data intensive computer sensing environment, such as to control the functions of a vehicle. For example, the computing system 100 can be embedded or otherwise disposed in a vehicle (e.g., a Mercedes-Benz^{®}car, truck, or van).

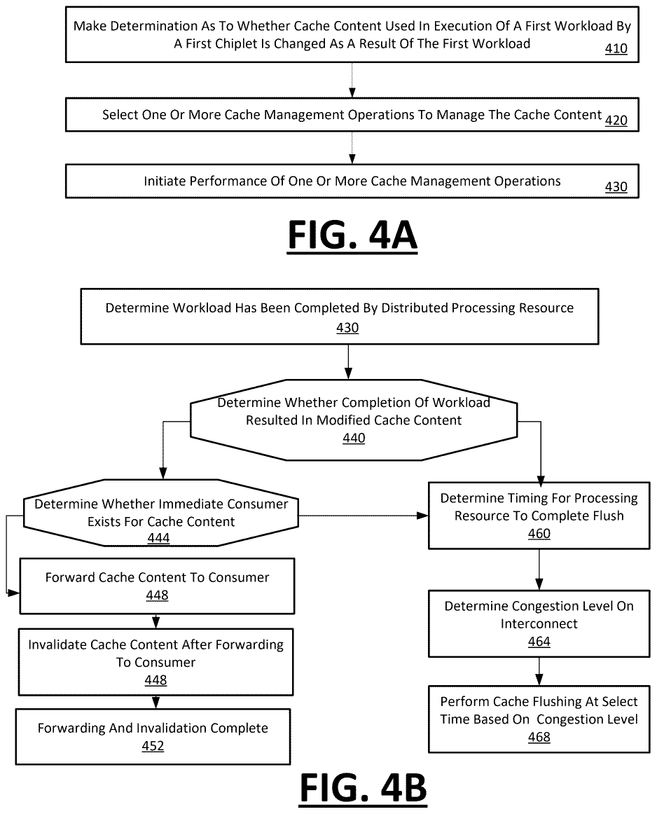

In an embodiment, the control circuit 110 and the one or more compute circuits 112 are programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform an example method such as described with FIG. 4A or FIG. 4B.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when the control circuit(s) 110 or other hardware components execute the modules or computer-readable instructions.

In further embodiments, the computing system 100 can include a communication interface 140 that enables communications over one or more networks 150 to transmit and receive data. In various examples, the computing system 100 can communicate, over one or more networks 150 and using the communication interface 140, with other vehicles (e.g., fleet vehicles), satellite systems (e.g., navigation satellites), cellular towers, or other types of communication mediums. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As shown in an example of FIG. 1, the main control circuit 110 is associated with a main memory 116. Each of the compute circuits 112 can be associated with a corresponding cache resource 114. The cache resource(s) 114 and the main memory 116 exchange data over an interconnect element 124. For example, a corresponding compute circuit 112 can initiate a workload, and the corresponding cache resource can retrieve initial cache content from the main memory 116, over the interconnect element 124. After completion of the workload, the cache resource 114 can perform a cache flushing operation, where the cache content used with execution of the workload is written back to the main memory 116. While the interconnect element 124 can be implemented as a high-bandwidth data transfer mechanism, the interconnect element 124 can support data transfer for numerous elements, meaning it may also be a critical aspect for enabling components of the computer system 100 to communicate with one another. Accordingly, as described in examples, objectives for implementing cache management operations can include reducing data congestion across the interconnect element 124. In variations, such objectives can further include reducing the amount of data transferred across the interconnect element 124, between the main memory 116 and the cache resources 114 of the compute circuits 112. Still further, as an addition or variation, the objective can include reducing the number of instances in which the data congestion across the interconnect element 124 exceeds a threshold value.

In some examples, the control circuit 110 identifies workloads for the compute circuits 112 to execute, where the workloads are determined from a statically laid out (“SLO”) application. Accordingly, each of the workloads are statically laid out, and the execution of the SLO workloads can follow a predetermined computational graph 105. The predetermined computational graph can be used to select cache management operations for compute circuits 112 to perform, based on an objective of reducing the occurrence of congestion across the interconnect element. The computational graph 105 can, for example, define the sequence and type operations performed with each workload, as well as the memory addresses that are accessed in the course of the workloads being executed. The SLO execution of applications enables every memory access operation and address to be determined prior to execution of a corresponding workload.

In examples, the main control circuit 110 utilizes the computation graph 105 to coordinate the execution of workloads with the compute circuits 112. This coordination can include, for example, identifying and scheduling workloads, tracking status of workloads (e.g., awaiting execution, executing, completed, etc.), and resolving dependencies which result from the performance of workloads by the various compute circuits 112. When a workload is distributed to a compute circuit 112, the compute circuit can retrieve an initial cache content from the main memory 116, where the initial cache content is stored with the associated cache resource 114 of the respective compute circuit 112. Subsequently, the compute circuit 112 executes the workload using the cache content.

The control circuit 110 can implement, or initiate implementation, of cache management operations in connection with individual compute circuits 112 completing corresponding workloads. In examples, the control circuit 110 determines which cache management operation is to be performed by individual compute circuits 112 as they complete workloads. For a particular workload, the main control circuit 110 can determine, from the computation graph 105, whether the initial cache content for the workload was changed in the course of the workload being executed by a designated compute circuit 112. The control circuit 110 can make the determination by determining whether execution of the workload requires performance of any write-type operations, or whether execution of the workload required only read-type operations. If any write-type operations are expected to be performed, then the main control logic 110 determines that the cache content of the respective compute circuits 112 has been modified, as compared to a reference state for the cache content, reflecting the state of the cache content after it is initially retrieved from the main memory 116, when execution of the workload is initiated. If only read-type operations are performed in the course of the workload being executed, then the control logic 110 determines that the cache content of the respective compute circuits has not been modified. The determination as to whether the cache content is changed or not can form a basis for selecting cache management operation(s) that are to be performed.

The cache management operations can be implemented to optimize for preventing or reducing data congestion across interconnect elements of the computer system 100, by (i) reducing a number of instances when the compute circuit(s) 112 perform cache flushing operations; and/or (ii) timing when the compute circuit(s) 112 perform a cache flushing operation, based on available bandwidth of interconnect elements (such as represented by interconnect element 124) extending between the compute circuit(s) 112 and the control circuit 110 where the main memory 116 is located.

In examples, the cache management operations include a cache flushing operation, a cache forwarding operation, and a cache invalidation operation. The control circuit 110 uses the computational graph 105 for executed workloads to select the cache management operations. When the computational graph 105 indicates the cache content is changed, the control circuit 110 can notify or otherwise instruct the corresponding compute circuit 112 to forward the cache content to another processing resource 112 of the computer system 100. For example, the control circuit 110 can use the computational graph 105 to identify whether there is compute circuit 112 that requires the cache content, and the control circuit 110 can notify the current compute circuit 112 to forward its cache copy to that processing circuit 112 that requires use of the cache content. Further, the control circuit 110 can instruct, or otherwise cause the forwarding compute circuit 112 to invalidate its cache copy. By forwarding and then invalidating, the cache content used by the completed compute circuit 112 is not transmitted to the main memory 116, meaning the congestion level across interconnects such as represented by the interconnect element is reduced.

Further, the control circuit 110 can select the cache management operation to be a cache flushing operation. A cache flushing operation can be selected when, for example, the cache content used by a compute graph 105 in completing a workload is unchanged, and/or when there is no immediate consumer or need for the cache content used by a completed compute circuit 112. In such cases, the control circuit 110 can determine whether the compute circuit should delay performing the cache flush operation, for purpose of, for example, balancing the congestion across the interconnect elements of the computer system 100. A delayed cache flushing operation can be selected when certain conditions are present. To determine whether the cache flushing operation is to be delayed, the control circuit 110 determines one or more of (i) a remaining time interval until the completed compute circuit 112 receives another workload, (ii) a current congestion level of the interconnect element(s) used to perform the cache flushing operation, and/or (iii) an expected congestion level of the interconnect element 124 during the time interval preceding when the completed compute circuit 112 is to initiate performance of another workload. The determinations for delaying the cache flushing operation can be made by the control circuit 110, using the computation graph 105 (e.g., to determine when the completed compute circuit 112 is to start a new workload) and/or information provided by the interconnect element 124 (e.g., current congestion level). In some variations, the determinations for delaying the cache flushing operation can be made by the completed compute circuit 112, by, for example, the completed compute circuit 112 reading congestion level information for the interconnect element 124.

### System On Chip

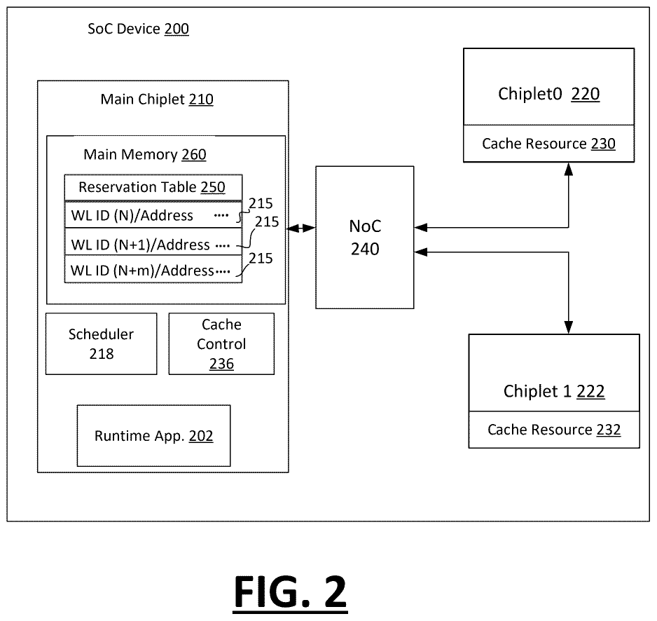

FIG. 2 illustrates an example system on chip (SoC) device, according to one or more embodiments. As shown, the SoC 200 includes a plurality of chiplets, including a main chiplet 210 and multiple compute chiplets 220, 222. The main chiplet 210 and/or the SoC device 200 can serve as an electronic control unit for a larger system.

In a typical SoC environment, the execution of a runtime application 202 involves numerous data exchanges with other chiplets, with tasks being sequenced or dependent on other tasks (which may be performed by other chiplets). Further, while an example of FIG. 2 illustrates a simplified version of an SoC arrangement, the SoC 200 can execute multiple applications, as well as utilize any number of chiplets in conjunction with the main chiplet 210.

According to examples, the main chiplet 210 includes a main memory 260 where a reservation table 250 is maintained. The main chiplet 210 also includes logic represented by a scheduler 218, to update the reservation table 250. The scheduler 218 can identify, schedule and monitor workloads amongst the computation chiplets 222, 224, where each workload represents tasks that are to be performed in connection with the execution of a runtime application 202. Each compute chiplet 220, 222 communicates with the main chiplet 210 using a high speed interconnect resource. In an example shown, the interconnect resource between the main chiplet 210 and the compute chiplets 220, 220 is a network-on-chip (NoC) interconnect 240. In an example configuration shown by FIG. 2, each compute chiplet 220, 222 is associated with a corresponding cache resource 230, 232. Further, the main chiplet 210 can implement control logic 236 to manage the distributed set of cache resources 230, 232, in a manner that maintains coherency and accuracy, while minimizing congestion across interconnect resources of the SoC 200.

In examples, the runtime application 202 generates tasks related to the control or operation of a vehicle, including the autonomous operation of a vehicle. The main chiplet 210 includes processes, represented by a scheduler 218, to identify workloads from the execution of the runtime application 202. As described, the runtime application 202 can be statically laid out and represented by a computation graph 205. The scheduler 218 populates the reservation table 250 based in part on information obtained from a computation graph 205 of the runtime application 202. The scheduler 218 can use the computation graph 205 to (i) identify the workloads of the runtime application 202; (ii) schedule performance of workloads, including sequencing and identifying dependencies amongst workloads; and (iii) identify memory access operations performed by operations (e.g., read-or write-type operations), as well as memory addresses of the data that is accessed.

Further, the scheduler 218 can be implemented with cache control logic 236 to track cache content usage information for each workload. The cache content usage information can include (i) location information for cache content used by a workload, and (ii) an indicator as to whether the cache content used in the execution of a workload is changed with completion of the workload. The indication can be based on whether any of the operations performed in the course of the workload are write-type operations that specify the cache content. If all of the operations that utilize the cache content during the execution of the workload are read-type operations, then the cache content for the workload is deemed to not change with completion of the workload.

The control logic 236 can be implemented to determine cache content usage information for individual workloads based on information provided or determined from the computation graph 205 of the runtime application 202. The control logic 236 can determine the cache content usage information for a particular workload based on the memory access operations specified with the workload, the type and subtype of the functions performed by the workload, and/or the type of operations (e.g., write-type or read-type) performed during execution of the workload. As the scheduler 218 can use the computation graph 205 to determine the cache content usage information, the scheduler 218 can determine the cache content usage information for the computation chiplets 220, 222 that perform the workloads independently. For example, the cache content usage information can be determined before a workload is completed or even distributed to a corresponding computation chiplet 220, 222. Accordingly, in examples, as the application 202 executes, the scheduler 218 populates the reservation table 250 with workload entries 215, where each workload entry 215 corresponds to a portion (or workload) of the runtime application 202 being executed. Each workload entry 215 can be implemented as a data structure (e.g., 64-bit data structure) that identifies a workload, a chiplet performing the workload, dependencies of the workload, as well as the type and subtype of functionality and operations performed in the execution of the respective workload.

In examples, when one of the computation chiplets 220, 222 completes a particular workload, the computation chiplet 220, 222 performs one or multiple cache management operations, as directed by the cache control logic 236. The cache control logic 236 can determine the cache management operation based at least in part on a determination as to whether the execution of the particular workload by the respective computation chiplets changed the cache content used in the execution of the particular workload. The cache control logic 236 can also determine the cache management operation based at least in part on a determination as to whether another computation chiplet 220, 222 is slated to be an immediate consumer of the cache content used in the execution of the particular workload. The latter determination can also be based at least in part on the computation graph 205, and the resolution of dependencies (e.g., dependent workloads) for the consumer chiplet that is to consume the cache content of the prior chiplet. Based on the determination(s), the cache control logic 236 specifies the cache management operation(s) that are to be performed.

In examples, the cache management operation(s) includes one or multiple operations (e.g., sequenced operations), including one of either a cache invalidation operation or a cache flushing operation. When a compute chiplet 220, 222 performs a cache flush operation, a cache line that is modified as compared to a point of reference (e.g., the initial version of the cache content, as received by the compute chiplet 220, 222 from the main memory) is updated within the main memory 260. A cache invalidation operation, on the other hand, occurs locally on the respective compute chiplet, effectively rendering the corresponding cache resource useless until it is written over again with new cache content.

By way of examples, when completion of a first workload by a first compute chiplet 220 is deemed to change the cache content used in the execution of the first workload, the scheduler 218 determines whether there is an immediate consumer for the cache content. If there is an immediate consumer (e.g., second compute chiplet 222) for the cached content of the first compute chiplet 220, the scheduler 218 notifies the first compute chiplet 220 to forward the cache content used with execution of the first workload to the second compute chiplet 222. As described with examples, the cache content can be forwarded via an interconnect element between the first and second computation chiplets 220, 222. Alternatively, the first compute chiplet 220 and the second compute chiplet 222 can utilize a shared cache resource. The first compute chiplet 222 can then forward a reference (e.g., memory pointer) for its cache content to the second compute chiplet 222, and the second chiplet 222 can perform a corresponding workload by using the forwarded reference to access the forwarded cache content from the shared cache resource, for purpose of performing its workload. After performing the forwarding, the compute chiplet 220 invalidates the cache content used to perform the workload. After invalidating its cache content, the compute chiplet 220 notifies, or otherwise indicates its completion to the reservation table 250.

On the other hand, if there is no immediate consumer for cache content of the first compute chiplet 220, then no forwarding may occur. Then, following completion of the first workload, examples provide that the first computing chiplet 220 can perform a cache flush operation.

When completion of a first workload by a first compute chiplet 220 is deemed to not change the cache content used in the execution of the workload (e.g., one or more write-type operations are performed), then the first compute chiplet 220 performs a cache flushing operation, where cached content from completion of the first workload is written to the main memory 260. The cache flushing operation utilizes the interconnect between the cache resource 234 of the first chiplet 220 and the main memory 260, shown in an example of FIG. 2 as being the NoC component 240.

As described above, performance of the cache flushing operation can include a delay operation, where the flushing operation is delayed until an event or condition is detected. The event can correspond to, for example, a particular time (e.g., number of cycles after completion of the workload, during a particular range of cycles, etc.). When the particular time is detected, the first chiplet 220 can initiate its flushing operation. In an example, the main chiplet 210, implementing the cache control logic 236, can determine when the first chiplet 220 is to initiate the flushing operation (e.g., after X cycles after completion of workload), and the first chiplet 220 then initiates the flushing operation at the appropriate time.

In variations, the condition that determines when the delayed flushing operation is performed can be based on a congestion level of the NoC component 240 (or other interconnect element between the respective cache resource and main memory 260). The NoC component 240 can include, for example, intrinsic functionality where its congestion level is published to the main chiplet 210. The first chiplet 220 can determine when the congestion level of the NoC component 240 is suitable (e.g., below a threshold) based on information made available by the NoC component 240. Alternatively, the timing information as to when the delayed flushing operation is performed can be determined from the main chiplet, which can make the determination based on the information provided by the NoC component 240.

Further, in examples, a delay to the cache flushing operation can be subject to a constraint of a time interval until when the first chiplet 220 is to be initiate performance of a next workload. The scheduler 218 can determine, from the reservation table 250, when the first chiplet 220 is to receive the next workload. For example, the main chiplet 210 can determine, from the reservation table 250, the number of cycles until the first chiplet 220 is to receive a next work order. If, for example, the first chiplet 220 is to immediately start on a new workload (e.g., based on dependencies for the new workload being resolved), then the flushing operation may not be delayed, but immediately initiated. If, on the other hand, the first chiplet 220 has 1000 cycles until initiating a second workload, then the cache control logic 236 can specify a time during the interval (e.g., particular cycles in the interval) when the flushing operation is to be performed. Alternatively, the determination can be based on traffic/congestion information, communicated with the NoC. In the latter case, the determination can be made by either of the main chiplet 210 or the compute chiplet 220, based on implementation.

In this way, examples enable a distributed architecture for compute chiplets of the SoC 200, where the negative affects associated with cache flushing operations are minimized. As described, in the distributed architecture, cache management operations can include (i) causing the computing chiplets 220, 222 to selectively perform cash invalidation operations in place of cache flushing operations, and/or (ii) causing compute chiplets 220, 222 to select a time when to perform the cache flushing operation, rather than just perform the flushing operation immediately upon completion of its workload. These steps service to reduce the occurrence of instances when traffic across the NoC component 240 is at a maximum acceptable level, while also reducing the overall amount of data transfer that would otherwise be required as a result of the compute chiplets 220, 222 performing cache flush operations after completing each of their respective workloads.

### Vehicle Control Unit

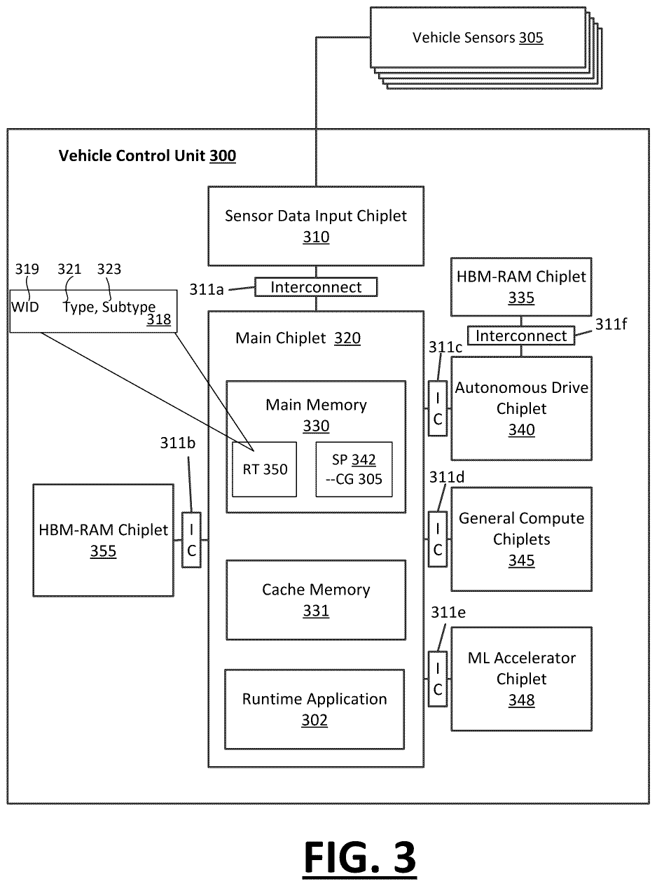

FIG. 3 is a block diagram illustrating a vehicle control unit 300, according to one or more embodiments. A vehicle control unit 300 provides an example of an electronic control unit, such as shown and described with an example of FIG. 2. With reference to FIG. 3, the vehicle control unit 300 can be implemented as a system on chip (SoC) or multiple systems on chip (mSoC) device, for purpose of controlling various types of vehicle operations, such as autonomous operation of vehicles. Based on implementation, the vehicle control unit 300 can include additional components, and the components of the vehicle control unit 300 can be arranged in various alternative configurations other than the example shown. Thus, the vehicle control unit 300 of FIG. 3 is described herein as an example arrangement for illustrative purposes and is not intended to limit the scope of the present disclosure in any manner.

The vehicle control unit 300 can include a set of chiplets, including a main chiplet 320 comprising a shared memory 330 and a set of workload chiplets, which in an example shown include autonomous drive chiplet 340, general compute chiplet 345, and master accelerator chiplet 348. The sensor data input chiplet 310 can generate workload entries for a reservation table 350 comprising identifiers for the sensor data (e.g., an identifier for each obtained image from various cameras of the vehicle's sensor system) and provide an address of the sensor data in the cache memory 331.

In various implementations, the shared memory 330 can store programs and instructions for performing vehicle control tasks. The shared memory 330 of the main chiplet 320 can further include a reservation table 350 that provides the various chiplets with the information needed (e.g., sensor data items and their locations in memory) for performing their individual tasks. The main chiplet 320 also includes the large cache memory 331, which supports invalidate and flush operations for stored data.

Accordingly, the reservation table 350 can include workload entries, each of which indicates a workload identifier that describes the workload to be performed, an address in the cache memory 331 and/or HBM-RAM of the location of raw or processed sensor data required for executing the workload, and any dependency information corresponding to dependencies that need to be resolved prior to executing the workload. In certain aspects, the dependencies can correspond to other workloads that need to be executed.

When workloads are completed by the chiplets, dependency information for additional workloads in the reservation table 350 can be updated to indicate so, and the additional workloads can become available for execution in the reservation table when no dependencies exist. In certain examples, the chiplets can monitor the reservation table 350 by way of a workload window and instruction pointer arrangement, in which each entry of the reservation table 350 is sequentially analyzed along the workload window by the workload processing chiplets. If a particular workload is ready for execution (e.g., all dependencies are resolved), the workload processing chiplets can execute the workload accordingly. When a workload is executed by a particular chiplet, the chiplet updates the dependency information of other workloads in the reservation table 350 to indicate that the workload has been completed. This can include changing a bitwise operator or binary value representing the workload (e.g., from 0 to 1) to indicate in the reservation table 350 that the workload has been completed. Accordingly, the dependency information for all workloads having dependency on the completed workload is updated accordingly.

Once the dependencies for a particular workload are resolved, the workload entry can be updated through execution of a scheduling program 342. When no dependencies exist for a particular workload as referenced in the reservation table 350, the workload can be executed in a respective pipeline by a corresponding workload processing chiplet. The workload entries can be distributed to the workload processing chiplets. The workload processing chiplets can monitor and update the reservation table 350 comprising workload entries. Further, the workload entries can include cache addresses of workload data for executing a respective workload, as well as dependency information that is to be resolved before executing the respective workload.

Referring to FIG. 3, a sensor data input chiplet 310 of the vehicle control unit 300 can receive sensor data from various vehicle sensors 305. The vehicle sensors 305 can include, for example, any combination of image sensors (e.g., single cameras, binocular cameras, fisheye lens cameras, etc.), LIDAR sensors, radar sensors, ultrasonic sensors, proximity sensors, and the like. The sensor data input chiplet 310 can automatically dump the received sensor data as it's received into a cache memory 331 of the main chiplet 320. The sensor data input chiplet 310 can also include an image signal processor (ISP) responsible for capturing, processing, and enhancing images taken from the various vehicle sensors 305. The ISP takes the raw image data and performs a series of complex image processing operations, such as color, contrast, and brightness correction, noise reduction, and image enhancement, to create a higher-quality image that is ready for further processing or analysis by the other chiplets of the vehicle control unit 300. The ISP may also include features such as auto-focus, image stabilization, and advanced scene recognition to further enhance the quality of the captured images. The ISP can then store the higher-quality images in the cache memory 331.

The sensor data input chiplet 310 can obtain sensor data from the vehicle sensors 305. The sensor data input chiplet 310 stores, or causes to be stored, sensor data (e.g., image data, LIDAR data, radar data, ultrasonic data, etc.) in the cache memory 331. The sensor data input chiplet 310 can generate an identifier for the sensor data (e.g., an identifier for each obtained image from various cameras of the vehicle's sensor system) and indicate an address of the sensor data in the cache memory. The identifier and address of the sensor data can be referenced in the reservation table 350 that includes workload identifiers, dependency information for each workload, and addresses of the necessary data to execute a particular workload. The reservation table 350 can be referenced by the workload processing chiplets to execute the workloads.

In some aspects, the sensor data input chiplet 310 publishes identifying information for each item of sensor data (e.g., images, point cloud maps, etc.) to a shared memory 330 of a main chiplet 320, which acts as a central mailbox for synchronizing workloads for the various chiplets. The identifying information can include details such as an address in the cache memory 331 where the data is stored, the type of sensor data, which sensor captured the data, and a timestamp of when the data was captured.

To communicate with the main chiplet 320, the sensor data input chiplet 310 transmits data through an interconnect 311a. Interconnects 311a-f each represent die-to-die (D2D) interfaces between the chiplets of the vehicle control unit 300. In some aspects, the interconnects include a high-bandwidth data path used for general data purposes to the cache memory 331 and a high-reliability data path to transmit functional safety and scheduler information to the shared memory 330. Depending on bandwidth requirements, an interconnect may include more than one die-to-die interface. For example, interconnect 311a can include two interfaces to support higher bandwidth communications between the sensor data input chiplet 310 and the main chiplet 320.

In one aspect, the interconnects 311a-f implement the Universal Chiplet Interconnect Express (UCIe) standard and communicate through an indirect mode to allow each of the chiplet host processors to access remote memory as if it were local memory. This is achieved by using a specialized Network on Chip (NoC) Network Interface Unit (NIU) (allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the vehicle control unit 300 can include additional chiplets that can store, alter, or otherwise process the sensor data cached by the sensor data input chiplet 310. The vehicle control unit 300 can include an autonomous drive chiplet 340 that can perform the perception, sensor fusion, trajectory prediction, and/or other autonomous driving algorithms of the autonomous vehicle. The autonomous drive chiplet 340 can be connected to a dedicated HBM-RAM chiplet 335 in which the autonomous drive chiplet 340 can publish all status information, variables, statistical information, and/or processed sensor data as processed by the autonomous drive chiplet 340.

In various examples, the vehicle control unit 300 can further include a machine-learning (ML) accelerator chiplet 340 that is specialized for accelerating AI workloads, such as image inferences or other sensor inferences using machine learning, in order to achieve high performance and low power consumption for these workloads. The ML accelerator chiplet 340 can include an engine designed to efficiently process graph-based data structures, which are commonly used in AI workloads, and a highly parallel processor, allowing for efficient processing of large volumes of data. The ML accelerator chiplet 340 can also include specialized hardware accelerators for common AI operations such as matrix multiplication and convolution as well as a memory hierarchy designed to optimize memory access for AI workloads, which often have complex memory access patterns.

The general compute chiplets 345 can provide general purpose computing for the vehicle control unit 300. For example, the general compute chiplets 345 can comprise high-powered central processing units and/or graphical processing units that can support the computing tasks of the main chiplet 320, autonomous drive chiplet 340, and/or the ML accelerator chiplet 348.

Cache miss and evictions from the cache memory 331 are sent by a high-bandwidth memory (HBM) RAM chiplet 355 connected to the main chiplet 320. The HBM-RAM chiplet 355 can include status information, variables, statistical information, and/or sensor data for all other chiplets. In certain examples, the information stored in the HBM-RAM chiplet 355 can be stored for a predetermined period of time (e.g., ten seconds) before deleting or otherwise flushing the data. For example, when a fault occurs on the autonomous vehicle, the information stored in the HBM-RAM chiplet 355 can include all information necessary to diagnose and resolve the fault. Cache memory 331 keeps fresh data available with low latency and less power required compared to accessing data from the HBM-RAM chiplet 355.

As provided herein, the shared memory 330 can house a mailbox architecture in which a reflex program comprising a suite of instructions is used to execute workloads by the main chiplet 320, general compute chiplets 345, and/or autonomous drive chiplet 340. In certain examples, the main chiplet 320 can further execute a functional safety (FuSa) program that operates to compare and verify output of respective pipelines to ensure consistency in the ML inference operations. In still further examples, the main chiplet 320 can execute a thermal management program to ensure that the various components of the vehicle control unit 300 operates within normal temperature ranges. Further description of the shared memory 330 in the context of out-of-order workload execution in independent deterministic pipelines is provided below with respect to FIG. 3.

In examples, the scheduler 342 identifies workload entries for the reservation table 350. Each workload entry 318 can include an identifier 319, a type field 321, one or more subtype fields 323, dependency information for the identified workload, state information that identifies a state of the workload, and additional information. The type/sub-types can be specific to a variety of attributes, such as a function type and a source input. As described with other examples, the scheduler 342 populates in part the reservation table 350 using the predetermined computation graph for the runtime application 302.

In examples, the scheduler 342 continuously schedules workloads with the reservation table 350, as dependencies are resolved. Upon individual chiplets completing respective workloads, the chiplets notify the scheduler 342 that the workload is complete, and the scheduler 342 can update the reservation table 350 so that, for example, another workload that is dependent on the recently completed workload can be initiated. In example, each workload can be represented in the reservation table 350 as a 64-bit data structure, with the bit fields of the data structure being associated with workload identification, workload type and sub-type, and dependency information.

Accordingly, in examples, when any one of the workload chiplets completes a workload, it notifies the scheduler 342. As the scheduler 342 has knowledge of the operations performed by the completed chiplet from the predetermined computation graph, the scheduler 342 knows whether the cache content used in the performance of the workload is changed (e.g., by execution of a write-type operation). The scheduler 342 communicates with the completed chiplet to identify an immediate consumer chiplet (if one exists) for the cache content used by the completed workload chiplet. For example, in a scenario where chiplet0 completes a workload where cache content is modified, chiplet0 notifies the scheduler 342 when the workload has been completed. The scheduler 342 updates the reservation table 350, and from the reservation table 350, the scheduler 342 can identify another workload of another chiplet (“chiplet1”) that is dependent on the output of the workload completed by chiplet0. The scheduler 342 communicates that chiplet1 is an immediate consumer of the cache content of chiplet0. In turn, chiplet0 forwards the cache content generated from execution of its workload to chiplet1. While some examples provide for the forwarded cache content to be a copy operation, in examples, the chiplet0 forwards the cache copy by forwarding a cache reference or pointer to the chiplet1, where the cache reference or pointer identifies the cache content as modified by performance of chiplet0. Following forwarding, the chiplet0 can invalidate its own cache content. The forwarding of the cache content by one chiplet to another, as well as the subsequent invalidation by the forwarding chiplet, reduce the data congestion across the interconnect 311 which would otherwise be used in a cache flushing operation.

In another scenario, chiplet0 completes its workload, but the cache content is not changed. The scheduler 342 is notified of the workload being completed, and the scheduler 342 knows from the computation graph that the cache content used in completing the workload was unchanged. In such case, the chiplet completing the workload can be directed to perform a cache flushing operation, where cache content is written over the NoC interconnect 311 to the main memory 330. In such case, examples provide that the completed chiplet performs the cache flushing operation at a time when the congestion level of over the NoC interconnect 311 is below a threshold value. Alternatively, the cache flushing operation can be performed at a time when the congestion level across the NoC interconnect 311 is expected to be less, but before a time when the transferring chiplet is to initiate performance of another task.

### Methodology

FIG. 4A and FIG. 4B illustrate example methods for managing cache content in a distributed system, according to one or more embodiments. An example method of FIG. 4A and FIG. 4B can be implemented using examples such as described with FIG. 1 through FIG. 3. Accordingly, in describing examples of FIG. 4A and FIG. 4B, reference is made to elements of other examples for purpose of illustrating suitable components for performing a step or sub-step being described.

With reference to FIG. 4A, in a distributed system, a determination is made as to whether cache content used in execution of a first workload by a first chiplet is changed as a result of a first workload that is completed by the first chiplet (410). The determination can be made by analyzing a predetermined computation graph for the executed workload.

One or more cache management operations is selected in connection with execution of the first workload (420). The cache management operations can include a cache flushing operation, a cache forwarding operation, and a cache invalidation operation. The selection of the cache management operation can be based at least in part on whether the cache content associated with the execution of the prior workload has been changed. Further, the determination can be based on additional considerations that include whether there is an immediate need or consumer for the cache content of the completed workload.

In examples, the cache forwarding operation can be selected when the cache content of the completed workload is modified (as compared to a reference of when the cache content is initially retrieved from the main memory 260). In examples, the cache flushing operation can be performed when, for example, the completed workload does not result in the cache content being changed.

Additionally, the performance of one or more cache management operations is initiated (430). In examples, the cache controller 236 can initiate the cache forwarding operation by instruction or notification to the corresponding compute chiplet 220, 222. Likewise, the cache flushing operation can be initiated by the cache control logic 246 by instructing or notifying the compute chiplet 220, 222 to initiate flushing. As described, the cache flushing operation can also be implemented in a delayed manner.

With reference to FIG. 4B, a distributed processing resource completes a workload (430). The scheduler 342 schedules workloads from the reservation table 350 for performance by corresponding workload chiplets.

A determination is made as to whether the completed workload resulted in the cache content being modified by the processing resource that performed the workload (440). The scheduler 342 can make the determination of whether the cache content is modified based on the predetermined computation graph for the runtime application 302.

If the determination is that the cache content of the distributed processing resource is modified, then another determination can be made as to whether there is an immediate consumer (e.g., another distributed processing resource) for the cache content (444). The scheduler 342 can determine whether there is a consumer for the cache content based on the scheduling table 350.

If there is a consumer for the cache content, then the completed chiplet forwards the cache content to the consumer (another distributed processing resource) (452). After forwarding, the completed chiplet invalidates its cache content (456). Then, the completed chiplet notifies the main chiplet 310 that the invalidation of its cache content is complete.

If the determination at step 440 is that the cache content of the distributed processing resource is not modified, then a cache flushing operation is initiated. The timing parameters for delaying the cache flushing operation can be determined (460). The timing parameter can be based on the amount of time the completed chiplet has until the new workload is assigned. The timing parameter can be tracked, or otherwise determined by the scheduler 342. The congestion level on the interconnect component (e.g., NoC component 240) can also be determined (464). The congestion level can be provided by the NoC 311. The information can be determined by either of workload chiplet or the main chiplet, The completed chiplet performs the cache flushing at the select time based on the congestion level (468).

### Conclusion

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. An electronic control unit (ECU), the ECU comprising:
a plurality of chiplets to perform workloads used to control or perform functions for a vehicle, including functions to automate operation of a vehicle;
control logic configured to:
make a determination as to whether a cache content used in execution of a first workload of the plurality of workloads by a first chiplet of the plurality of chiplets is changed as a result of the first workload being executed by the first chiplet;
based on the determination, select one or more cache management operations to manage the cache content;
initiate performance of the one or more cache management operations;
wherein the plurality of chiplets are to perform the workloads for the vehicle functions based on the cache content after the one or more cache management operations.

2. The ECU of claim 1, wherein the control logic makes the determination based on a precomputed computation graph associated with the plurality of workloads, the plurality of workloads being statically laid out.

3. The ECU of claim 2, wherein the control logic makes the determination by determining whether the first workload includes a write-type operation.

4. The ECU of claim 3, wherein the control logic analyzes the predetermined computation graph for the first workload to determine whether first workload includes the write-type operation.

5. The ECU of claim 1, wherein in response to determination that the cache content is changed, the control logic initiates performance of a first operation in which the cache content is forwarded from the first chiplet to a second chiplet of the plurality of chiplets.

6. The ECU of claim 5, wherein after the first operation is complete, the control logic initiates performance of a second operation to mark the cache content as invalid on the first chiplet.

7. The ECU of claim 6, wherein after the first operation is complete, the control logic initiates performance of a third operation to identify the second operation as complete.

8. The ECU of claim 1, wherein in response to the determination that the cache content is unchanged, the control logic initiates performance of flushing the cache content used by the first chiplet in the execution of the first workload.

9. The ECU of claim 8, wherein flushing of the cache content includes determining a congestion level for an interconnect element for transferring data from the first chiplet to a main memory, and wherein flushing the cache content is performed at a time that is determined based at least in part on the congestion level for the interconnect element.

10. The ECU of claim 9, wherein flushing the cache content is delayed until a time when the congestion level of the interconnect element is below a threshold.

11. The ECU of claim 10, wherein delaying the flushing of the cache content is subject to a constraint of a time when the first chiplet is to receive a next workload.

12. A method for managing cache usage, the method comprising:
making a determination as to whether a cache content used in execution of a first workload of a plurality of workloads is changed;
selecting a cache management action from a set of multiple cache management actions based at least in part on the determination; and
initiating performance of one or more operations for implementing the cache management action.

13. The method of claim 12, wherein making the determination includes determining that the execution of the first workload includes a write type operation; and wherein the selected cache management action is a cache invalidation action for invalidating the cache content of a first chiplet.

14. The method of claim 13, wherein initiating performance of the one or more operations includes forwarding the cache content to a second chiplet that is to utilize the cache content.

15. The method of claim 14, wherein initiating performance of the one or more operations includes, after forwarding the cache content to the second chiplet, marking, locally on the first chiplet, that the cache content is invalid.

16. The method of claim 15, wherein initiating performance of the one or more operations includes, upon completing forwarding of the cache content and marking the cache content as invalid, identifying the cache invalidation action as complete.

17. The method of claim 12, wherein making the determination includes determining that the execution of the first workload includes no write type operation; and
wherein the selected cache management action includes an operation of flushing the cache content from a first chiplet to a main memory of a main chiplet.

18. The method of claim 17, wherein initiating performance of the one or more operations includes determining a congestion level for an interconnect resource between the first chiplet and the main memory.

19. The method of claim 18, wherein performing one or more operations includes repeatedly determining the congestion level for the interconnect resource between the first chiplet and the main chiplet, and immediately initiating an operation to write the cache content from the first chiplet to the main memory in response to the congestion level being below a threshold.

20. The method of claim 12, wherein making the determination is based on a precomputed computation graph associated with the plurality of workloads, the plurality of workloads being statically laid out.
